(19) United States
(12) Patent Application Publication
(10) Pub. No.: US 2013/0181668 A1
(43) Pub. Date: Jul. 18, 2013

(54) NON-CONTACT CHARGING MODULE AND NON-CONTACT CHARGING INSTRUMENT

(71) Applicants: Kenichiro Tabata, Miyazaki (JP); Akio Hidaka, Miyazaki (JP); Tokuji Nishino, Miyazaki (JP)

(72) Inventors: Kenichiro Tabata, Miyazaki (JP); Akio Hidaka, Miyazaki (JP); Tokuji Nishino, Miyazaki (JP)

(73) Assignee: PANASONIC CORPORATION, Osaka (JP)

(21) Appl. No.: 13/876,509

(22) PCT Filed: Oct. 27, 2011
(86) PCT No.: PCT/JP2011/006025

§ 371 Date: Mar. 28, 2013

(30) Foreign Application Priority Data
Dec. 1, 2010 (JP) 2010-267985
Dec. 1, 2010 (JP) 2010-267986

(51) Int. Cl. H02J 7/00

(52) U.S. Cl. CPC H02J 7/0042
USPC 320/108

(57) ABSTRACT

Provided are a non-contact charging module and a non-contact charging instrument such that the non-contact module can be made thin in a state where a sufficient cross-sectional area of a planar coil portion has been ensured and power transmission efficiency has been enhanced. The non-contact module comprises the planar coil portion (2) on which a plurality of conducting wires have been spirally wound, and a magnetic sheet provided so as to oppose a surface of a coil (21) of the planar coil portion (2), the plurality of conducting wires are respectively connected together at both ends, and the planar coil portion (2) has a part wound overlapped in multiple layers and another part wound in a single layer.

### TECHNICAL FIELD

The present invention relates to a non-contact charging module that includes a planar coil section formed of a spirally wound conducting wire and a magnetic sheet, and a non-contact charging instrument using the same.

### BACKGROUND ART

In recent years, a technique that can charge a main instrument in a non-contact manner by a charger has been widely used. According to this technique, a power transmission coil is disposed on the charger side and a power reception coil is disposed on the main instrument side, and electromagnetic induction is generated between both the coils. Thus, electric power is transmitted from the charger side to the main instrument side. Further, a technique in which a mobile terminal instrument or the like is applied as the main instrument has also been proposed.

In the main instrument such as a mobile terminal instrument or the charger, it is desirable to reduce the thickness and size. In order to meet such a demand, as disclosed in Patent Literature (hereinafter, abbreviated as PTL) 1, a configuration may be considered that includes a planar coil section as a power transmission coil or a power reception coil, and a magnetic sheet. Further, in order to reduce an increase in the effective resistance in a high frequency region, in a planar coil as disclosed in PTL 2, a plurality of conducting wires parallel to each other are arranged in a planar shape and are spirally wound and end portions of the respective conducting wires are electrically connected to each other in a coil lead portion.

### CITATION LIST

### Patent Literature

### PTL 1

Japanese Patent Application Laid-Open No. 2006-42519

### PTL 2

Japanese Patent Application Laid-Open No. 2010-16235

### SUMMARY OF INVENTION

### Technical Problem

However, in a non-contact charging module that includes the planar coil section of a single wire and the magnetic sheet of which the entire surface has a planar shape, such as an apparatus disclosed in PTL 1, the diameter of the conducting wire is increased in order to secure a necessary cross-sectional area of the conducting wire of the planar coil section, which obstructs reduction in the thickness as much. This is because if the cross-sectional area of the coil is small, alternating current resistance ACR of the coil is increased and transmission efficiency of the non-contact charging module is thus decreased. Thus, in general, the coil should have a diameter of at least about 0.25 mm, but in this case, the sum of thicknesses of the coil and the magnetic sheet is noticeably increased.

Further, in a non-contact charging module having the configuration disclosed in PTL 2, it is similarly difficult to secure a sufficient cross-sectional area of the planar coil section, and thus, it is difficult to achieve reduction in the thickness and size in a state where power transmission efficiency is enhanced.

An object of the present invention is to provide a non-contact charging module and a non-contact charging instrument that can reduce the thickness of the non-contact charging module in a state where a sufficient cross-sectional area of a planar coil section is secured and power transmission efficiency is enhanced.

### Solution to Problem

According to an aspect of the present invention, there is provided a non-contact charging module including: a planar coil section in which a plurality of conducting wires are wound; and a magnetic sheet on which a coil surface of the planar coil section is mounted, and which is provided to face the coil surface of the planar coil section, in which the plurality of conducting wires are connected to each other at both ends; the planar coil section has a first portion wound to be overlapped in multiple layers and a second portion, other than the first portion, wound in the number of layers smaller than the number of layers wound in the first portion; and the magnetic sheet is provided with an annular recess portion or slit so as to reduce thickness of the magnetic sheet in a portion of the magnetic sheet, the portion of the magnetic sheet faces the first portion of the planar coil section wound to be overlapped in multiple layers, and the plurality of conducting wires are accommodated in the annular recess portion.

### Advantageous Effects of Invention

According to the present invention, it is possible to reduce the size and thickness of the non-contact charging module in a state where a sufficient cross-sectional area of the planar coil section is secured and power transmission efficiency is enhanced.

### BRIEF DESCRIPTION OF DRAWINGS

FIG. 1 is an assembly drawing illustrating a non-contact charging module according to an embodiment of the present invention;

FIGS. 2A to 2D are conceptual diagrams illustrating the non-contact charging module according to the embodiment;

FIGS. 3A and 3B are conceptual diagrams illustrating a method of winding a coil of the non-contact charging module according to the embodiment;

FIG. 4A to 4D are conceptual diagrams illustrating a magnetic sheet of the non-contact charging module according to the embodiment;

FIG. 5 is a top view illustrating the magnetic sheet of the non-contact charging module according to the embodiment;

FIG. 6 is a diagram illustrating the relationship between the thickness of a ferrite sheet and a value L of the coil of the non-contact charging module according to the embodiment;

FIG. 7 is a diagram illustrating the relationship between the inner winding and the value L of the coil of the non-contact charging module according to the embodiment;

FIG. 8 is a diagram illustrating the relationship between the number of turns and the value L of the coil of the non-contact charging module according to the embodiment;

FIGS. 9A to 9D are conceptual diagrams illustrating a non-contact charging module in which the coil of the non-contact charging module according to the embodiment has a single layer structure;

FIGS. 10A to 10D are conceptual diagrams illustrating a magnetic sheet of the non-contact charging module in which the coil of the non-contact charging module according to the embodiment has a single layer structure; and

FIGS. 11A and 11B are conceptual diagrams illustrating a magnetic sheet of the non-contact charging module in which the coil of the non-contact charging module according to the embodiment has a single layer structure.

### DESCRIPTION OF EMBODIMENTS

### Embodiments

Hereinafter, embodiments of the present invention will be described in detail with reference to accompanying drawings.

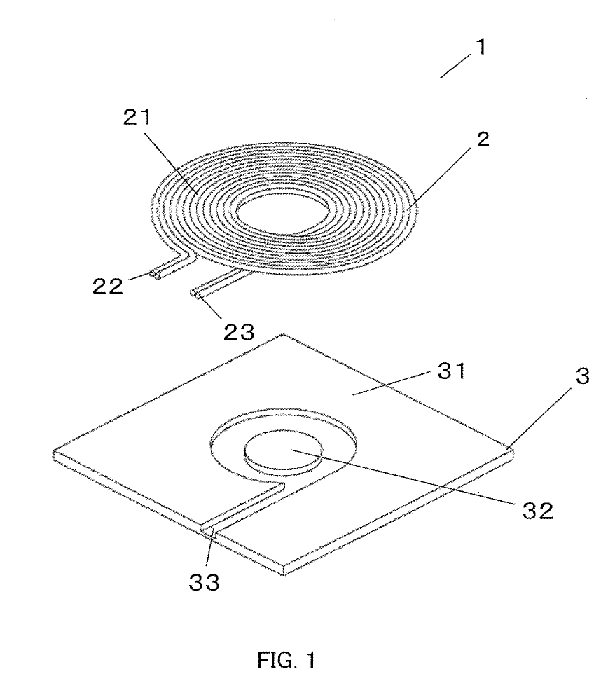

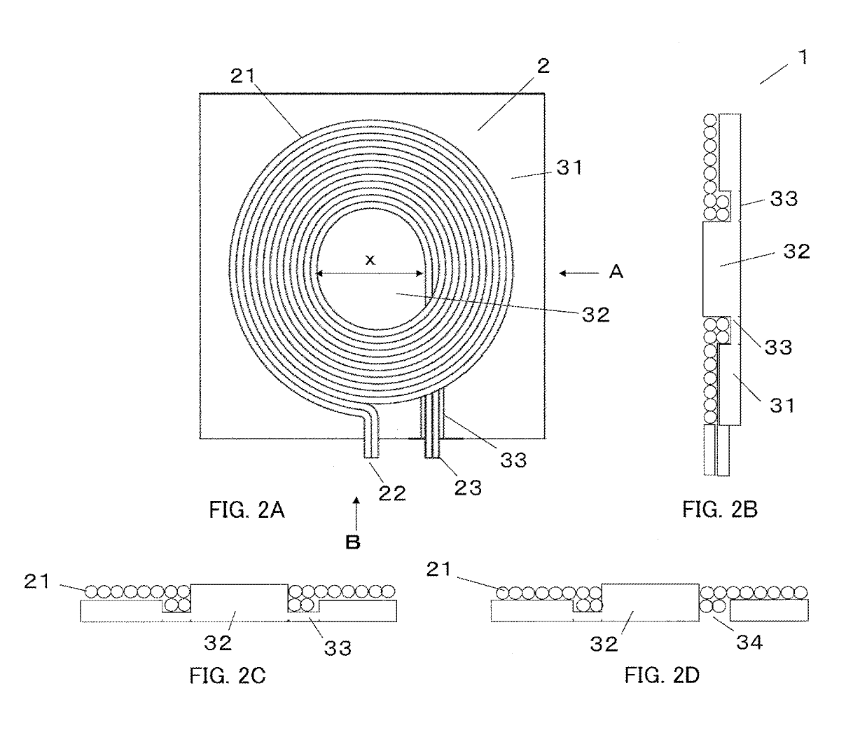

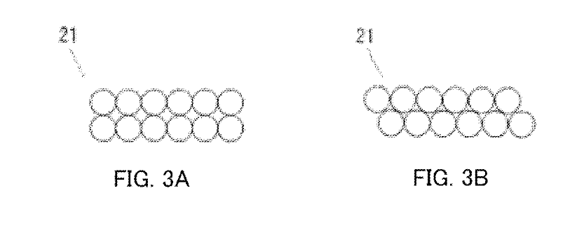

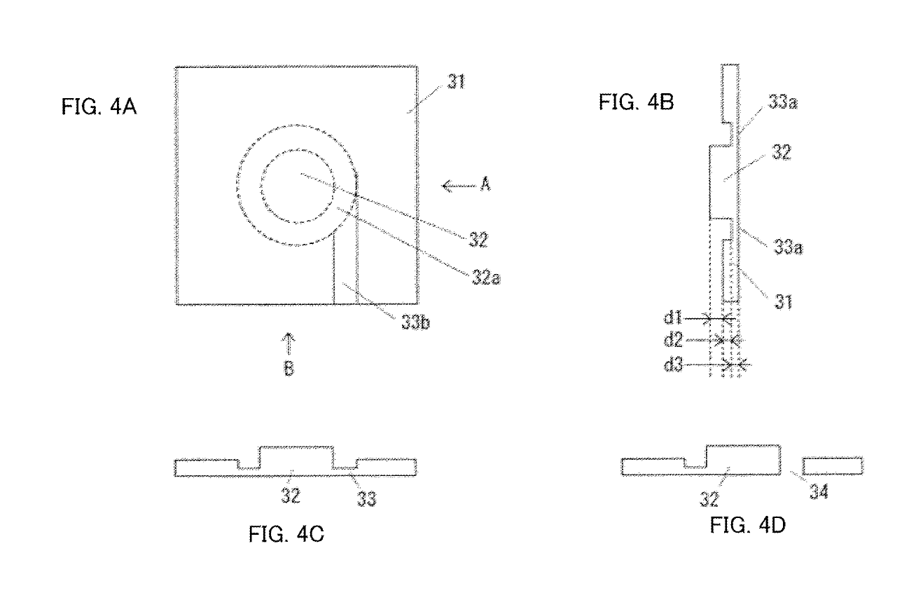

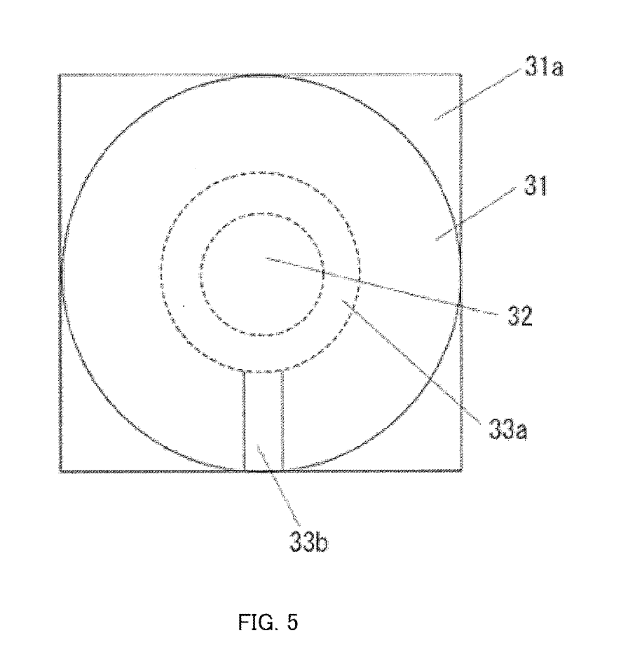

FIG. 1 is an assembly diagram illustrating a non-contact charging module according to an embodiment of the present invention. FIGS. 2A to 2D are conceptual diagrams illustrating the non-contact charging module according to the present embodiment, in which FIG. 2A is a top view, FIG. 2B is a cross-sectional view seen from direction A in FIG. 2A, and FIGS. 2C and 2D are cross-sectional views seen from direction B in FIG. 2A. FIGS. 3A and 3B arc conceptual diagrams illustrating a method of winding a coil of the non-contact charging module according to the present embodiment. FIG. 4A to 4D are conceptual diagrams illustrating a magnetic sheet of the non-contact charging module according to the present embodiment, in which FIG. 4A is a top view, FIG. 4B is a cross-sectional view seen from direction A in FIG. 4A, and FIGS. 4C and 4D are cross-sectional views seen from direction B in FIG. 4A. FIG. 5 is a top view illustrating the magnetic sheet of the non-contact charging module according to the present embodiment.

Non-contact charging module 1 according to the present invention includes planar coil section 2 in which a plurality of conducting wires are spirally wound, and magnetic sheet 3 provided to face a surface of coil 21 of planar coil section 2. The plurality of conducting wires are connected to each other at each of both ends, and planar coil section 2 has a part wound to be overlapped in multiple layers and another part wound in a single layer.

As shown in FIG. 1 and FIGS, 2A to 2D, planar coil section 2 includes coil 21 in which a conductor is wound in the radial direction to form a spiral shape on the surface, and terminals 22 and 23 provided at both ends of coil 21. Coil 21 is obtained by winding two conducting wires in parallel on a planar surface. A surface formed by the coil is referred to as a coil surface. Further, since two conducting wires are electrically connected to each other by soldering or the like in the portions of terminals 22 and 23, the two conducting wires seem like a single thick conducting wire. That is, the two conducting wires are wound around the same central axis in the planar form, and one conducting wire is inserted in the other conducting wire in the radial direction. In this way, as two conducting wires are electrically bonded to each other in the portions of terminals 22 and 23 to function as one conducting wire, it is possible to suppress the thickness with even the same cross-sectional area. That is, for example, the cross-sectional area of a conducting wire having a diameter of 0.25 mm may be obtained by preparing two conducting wires having a diameter of 0.18 mm. Accordingly, in the case of one conducting wire having the diameter of 0.25 mm, the thickness of one turn of coil 21 is 0.25 mm, and the width of coil 21 in the radial direction is 0.25 mm, whereas in the case of two conducting wires having the diameter of 0.18 mm, the thickness of one turn of coil 21 is 0.18 mm, and the width thereof in the radial direction is 0.36 mm. Here, the thickness direction represents a direction where planar coil section 2 and magnetic sheet 3 are stacked.

Further, coil 21 is overlapped in two layers in the thickness direction in only a part thereof on the central side, and is formed in a single layer in the remaining outer part thereof. At this time, the part at the central side of coil 21 is wound to be overlapped as shown in FIG. 3A or 3B. As shown in FIG. 3A, as the upper conducting wire and the lower conducting wire are wound to create a space therebetween, stray capacitance between the upper conducting wire and the lower conducting wire is decreased, and thus, it is possible to reduce AC resistance of coil 21.

Further, as shown in FIG. 3B as the upper conducting wire and the lower conducting wire are wound to fill the space therebetween, it is possible to reduce the thickness of coil 21.

Further, as shown in FIG. 3, in the present embodiment, the conducting wire has a circular cross-section, but may have a quadrate cross-section or the like. Here, in the case of the conducting wire having the circular cross-section area, since a gap occurs between adjacent conducting wires compared with the conducting wire having the quadrate cross-sectional area, stray capacitance between the conducting wires is decreased, and thus, it is possible to reduce AC resistance of coil 21.

Further, in a case where coil 21 is wound in a single layer, compared with a case where coil 21 is wound in double layers in the thickness direction, AC resistance of coil 21 is lowered and thus, transmission efficiency can be increased. This is because the stray capacitance between the upper conducting wire and the lower conducting wire is generated if the conducting wires are wound in double layers. Accordingly, it is preferable to wind a portion of coil 21 as much as possible in a single layer, instead of winding the entire of coil 21 in double layers. Further, by winding coil 21 in a single layer, it is possible to make thin non-contact charging module 1. As AC resistance of coil 21 is low, loss in coil 21 is prevented and the value L is improved. Thus, it is possible to enhance power transmission efficiency of non-contact charging module 1 depending on the value L.

Further, in the present embodiment, inner winding x of coil 21 shown in FIG. 1 is 10 mm to 20 mm, and an outer winding thereof is about 30 mm. As inner winding x is small, it is possible to increase the number of turns of coil 21 having the sane size in non-contact charging module 1, and to improve the value L.

Terminals 22 and 23 may be close to each other, or may be separated from each other, but non-contact charging module 1 is easily mounted in the separated arrangement.

Magnetic sheet 3 is provided to enhance power transmission efficiency of non-contact charging using electromagnetic induction, and includes flat portion 31, central convex portion 32, and recess portion 33, as shown in FIGS. 4A to 4D. Recess portion 33 may be slit 34. Further, in the present embodiment, a Ni—Zn-based ferrite sheet, a Mn—Zn-based ferrite sheet, a Mg—Zn-based ferrite sheet or the like may be used as magnetic sheet 3. The ferrite sheet can lower AC resistance of coil 21 compared with a magnetic sheet of an amorphous metal. Central convex portion 32 is not necessarily provided.

In the present embodiment, magnetic sheet 3 has a size of about 33 mm×33 mm. Respective thicknesses of flat portion 31, convex portion 32 and recess portion 33 are set so that d1 is 0.2 mm, d2 is 0.2 mm, and d3 is 0.4 mm, in FIG. 4B. Power transmission efficiency of the non-contact charging module is enhanced as much as magnetic sheet 3 is thick. Thus, greater height d1 of convex portion 32 makes transmission efficiency of non-contact charging module 1 enhanced. However, since the thickness of non-contact charging module 1 is increased as much as height d1 of convex portion 32 is made larger than the diameter of the conducting wire, the height d1 of convex portion 32 is set to be approximately the same as the diameter of the conducting wire that forms coil 21. Further, the diameter of convex portion 32 is approximately the same as the inner winding of coil 21. That is, the axial center of coil 21 and the center of convex portion 32 approximately coincide with each other, and coil 21 is wound around convex portion 32. Further, d2 is approximately the same as the diameter of the conducting wire that forms coil 21, and the convex portion 33 is formed with the minimum depth. The reason why is that the deeper recess portion 33 is, the thinner magnetic sheet 3 becomes, and as a result, transmission efficiency of non-contact charging module 1 is lowered.

Recess portion 33 includes circular portion 33a that is formed to surround convex portion 32, and linear portion 33b that extends from circular portion 33a to an edge of magnetic sheet 3. The width of circular portion 33a is about 1 mm to about 2 mm, and the width of linear portion 33b is about 0.4 mm to about 1 mm (diameter of conducting wire + about 0.1 mm). Linear portion 33b is formed to be approximately perpendicular to the edge of magnetic sheet 3, and to be overlapped with a tangent line of an outer circumference of the circular portion. By forming linear portion 33b in this way, it is possible to form terminals 22 and 23 without bending the conducting wire. In this case, the length of linear portion 33b is about 15 mm to about 20 mm. Further, linear portion 33b may be formed in a portion where the edge of magnetic sheet 3 is the closest to the outer circumference of circular portion 33a, as shown in FIG. 5. Thus, it is possible to suppress the area where recess portion 33 is formed to the minimum, and to enhance transmission efficiency of non-contact charging module 1. In this case, the length of linear portion 33b is about 5 mm to about 10 mm. In any arrangement, an inner end portion of linear portion 33b is connected to circular portion 33a. Further, linear portion 33b may be differently arranged. That is, it is preferable that coil 21 have a single layer structure if possible. In this case, it may be considered that all turns of coil 21 in the radial direction are formed in a single layer structure, or that a part thereof is formed in a single layer structure while the remaining part thereof is formed in a double layer structure. Accordingly, it is possible to draw one of terminals 22 and 23 from an outer winding of coil 21, but the other one thereof should be drawn from the inside. Accordingly, a portion where coil 21 is wound and a portion from a winding end point of coil 21 to terminal 22 or 23 are necessarily overlapped with each other in the thickness direction. Thus, linear portion 33b may be provided in the overlapped portion.

Further, linear portion 33b may be recess portion 33 as shown in FIG. 4C, or may be slit 34 as shown in FIG. 4D. That is, if linear portion 33b is recess portion 33, since a through hole or a slit is not provided on magnetic sheet 3, it is possible to prevent magnetic flux from being leaked, and to enhance power transmission efficiency of non-contact charging module 1. On the other hand, in the case of slit 34, it is easy to form magnetic sheet 3. In the case of recess portion 33, the cross-sectional shape is not limited to the quadrate as shown in FIG. 4C and may be an arc or a circle.

The above-mentioned d1 and d2, the width of circular portion 33a, or the like depend on the diameter of the conducting wire, and thus, are not limited to the above values. Further, d1 and d2 are not necessarily the same. This is because the coil may be wound in three or more layers in the portion of circular portion 33a.

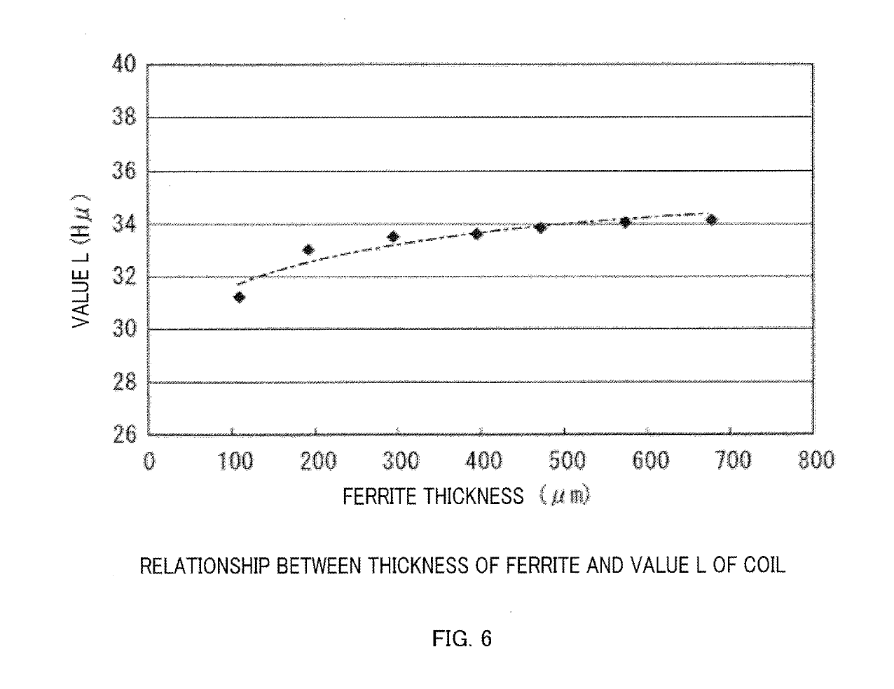

FIG. 6 is a diagram illustrating the relationship between the thickness of the ferrite sheet of the non-contact charging module according to the present embodiment and the value L of coil 21. Here, the thickness of the ferrite sheet refers to the sum of d2 and d3 in FIG. 4B, and is unrelated to convex portion 32. Accordingly, in the present embodiment, the thickness of the ferrite sheet is 0.6 mm. Further, at this time, the winding number of coil 21 is 30 turns, and the inner winding of coil 21 is 10 mm. As shown in FIG. 6, the value L of coil 21 exceeds 34 μH in the ferrite sheet having the thickness of about 0.6 mm. As a result, it is possible to satisfy the WPC standard that is a standard of non-contact charging module 1. Further, if the thickness of the ferrite sheet is 0.6 mm or greater, since the entire thickness of non-contact charging module 1 is increased, in the present embodiment, the thickness of the ferrite sheet is set to 0.6 mm. Moreover, when the thickness is 0.6 mm, an optimal value is obtained, which is applied to the ferrite sheet, and thus, in a case where the magnetic sheet of the amorphous metal is used, the thickness corresponding to an optimal value becomes different.

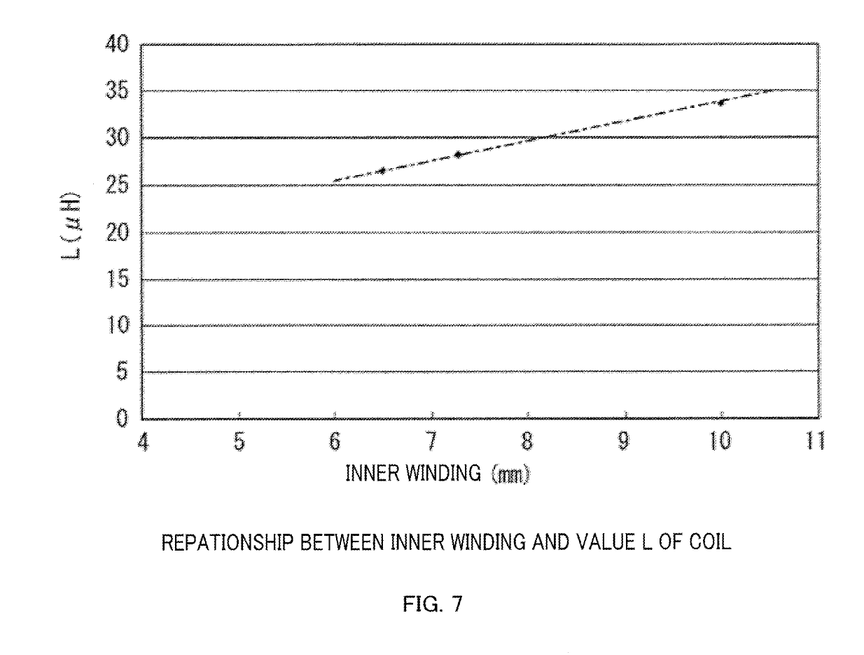

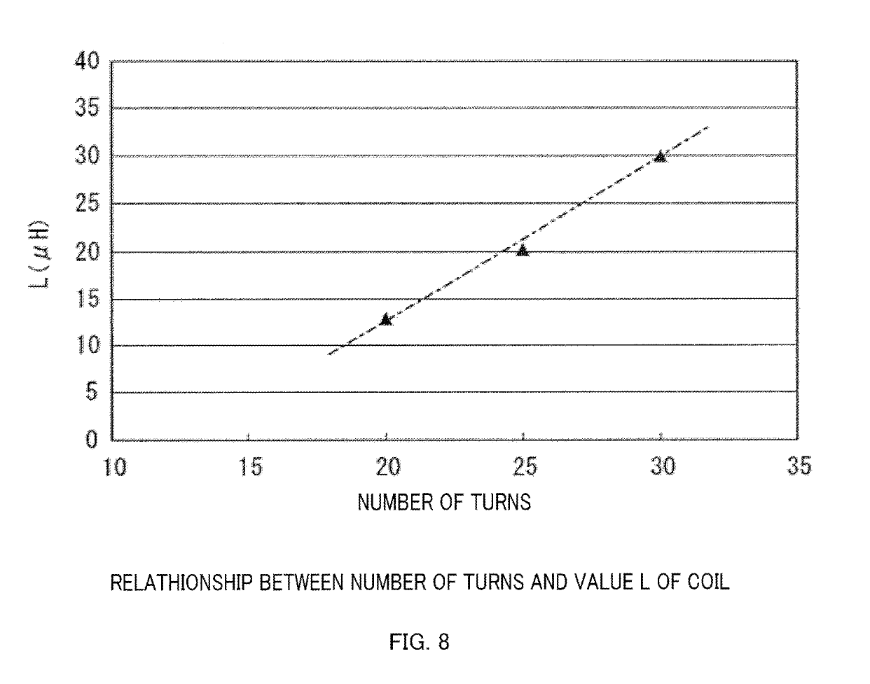

Next, the relationship between the inner winding and the value L of coil 21, and the relationship between the number of turns and the value L of coil 21 will be described. FIG. 7 is a diagram illustrating the relationship between the inner winding and the value L of coil 21 of the non-contact charging module according to the present embodiment, and FIG. 8 is a diagram illustrating the relationship between the number of turns and the value L of coil 21 of the non-contact charging module according to the present embodiment. In FIG. 7, the winding number of coil 21 is 30 turns, and in FIG. 8, the inner winding of coil 21 is 10 mm.

As the value L of coil 21 is high, transmission efficiency of non-contact charging module 1 is enhanced, and in order to satisfy the above-mentioned WPC standard, the value L should be about 30 μH. Accordingly, as is obvious from. FIGS. 7 and 8, it is necessary that the winding number of coil 21 be at least about 30 turns, and the inner winding of coil 21 be at least about 10 mm. However, since the thickness and size of non-contact charging module 1 are regulated by the size or the like of a battery pack of a mobile phone, for example, that is mounted with non-contact charging module 1, reduction in size and thickness is necessary.

Accordingly, in the present invention, two conducting wires are electrically connected at the portions of terminals 22 and 23, and caused to be equivalent to a single conducting wire having a large diameter. Reduction in the thickness is thereby achieved in a state where a cross-sectional area similar to that of a single conducting wire is secured. Further, since two conducting wires are used to result in the width of coil 21 in the radial direction larger than the case of one conducting wire, only the innermost portion is formed in the double layer structure. Thus, it is possible to sufficiently secure the winding number of coil 21 even in magnetic sheet 3 having a limited size. Further, it is possible to suppress the area of recess portion 33 to the minimum by setting the double layer structure on the inside, and it is thus possible to secure power transmission efficiency of non-contact charging module 1. Further, by setting the double layer structure on the inside and by increasing the portion of coil 21 formed in the single layer to the maximum, it is possible to reduce AC resistance, and to increase the value L. Further, by providing annular recess portion 33 formed by reducing the thickness of magnetic sheet 3 in the portion of magnetic sheet 3 that faces the portion wound to be overlapped in multiple layers of planar coil section 2, it is possible to cancel out the difference in the thickness between the portion overlapped in the multiple layers of the coil and the portion of the single layer, and to further achieve reduction in the thickness.

Further, convex portion 31a may be formed in a region where coil 21 is not disposed on flat portion 31, in four corners of magnetic sheet 3 as shown in FIG. 5. That is, on the outer portion of flat portion 31 surrounding the outer winding of coil 2 in the four corners of magnetic sheet 3, nothing is disposed on magnetic sheet 3. Accordingly, convex portion 31a can be formed in the outer portion to increase the thickness of magnetic sheet 3, and to enhance power transmission efficiency of the non-contact charging module. It is preferable that the thickness of convex portion 31a be large, but the thickness of convex portion 31a is approximately the same as the thickness of the conducting wire for reduction in the thickness, similar to central convex portion 32.

Further, coil 21 is not limited to annular winding, and may be wound in a quadrate or polygonal shape. Further, the inside may be wound to be overlapped in multiple layers, and the outside is wound in layers of which the winding number is smaller than the winding number on the inside. For example, the inside is formed as a three-layer structure, and the outside is formed as a double layer structure. This can also achieve the effects of the present invention.

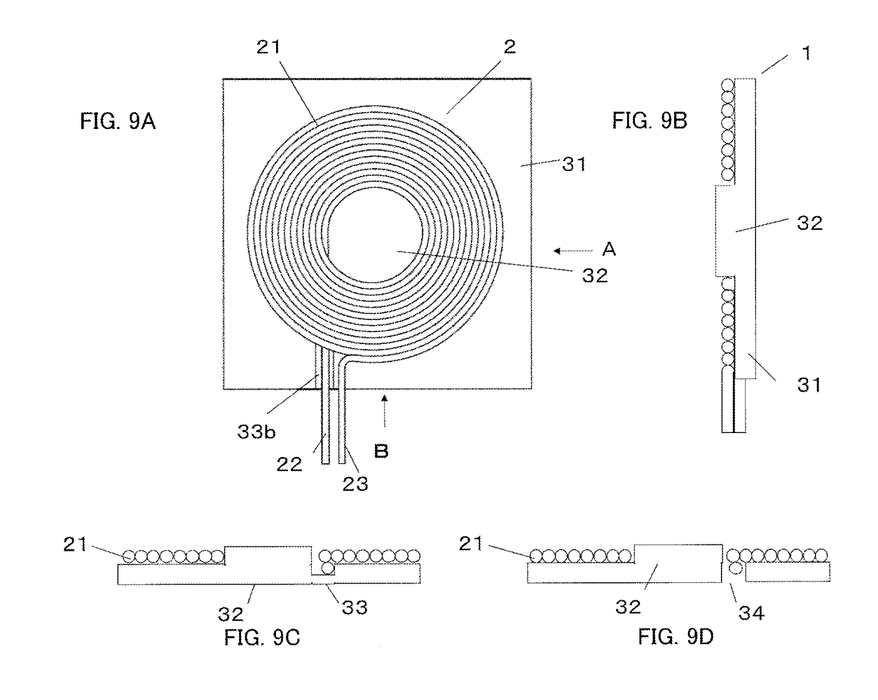

Next, convex portion 32, recess portion 33 and slit 34 in a case where circular portion 33a is not provided, according to another embodiment, will be described in detail. In FIGS. 9A to 9D to FIGS. 11A and 11B, it is assumed that coil 21 is formed by winding one conducting wire, but the present embodiment is not limited thereto.

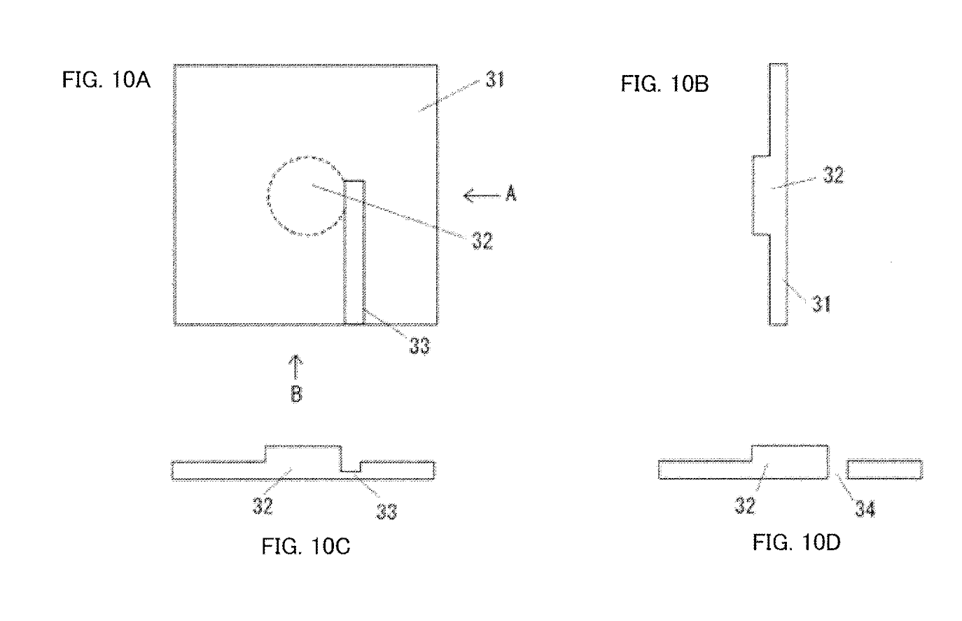

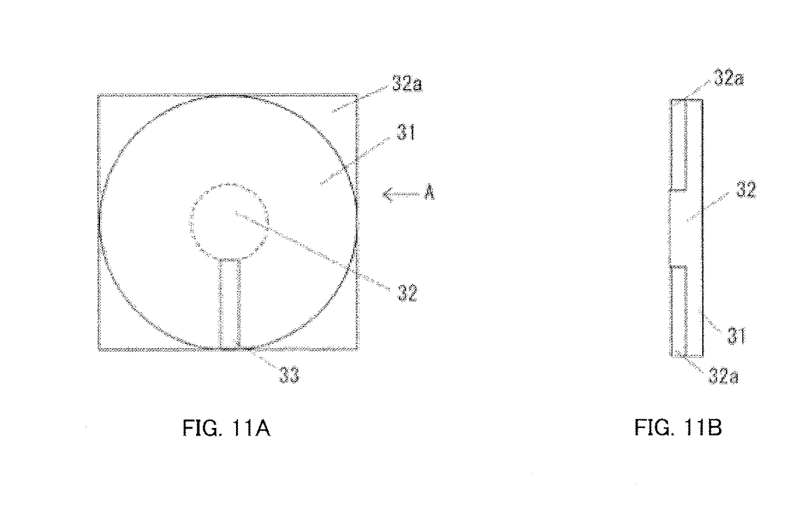

FIGS. 9A to 9D are conceptual diagrams illustrating a non-contact charging module in which a coil has a single layer structure according to the present embodiment, in which FIG. 9A is a top view, FIG. 9B is a cross-sectional view seen from direction A in FIG. 9A, and FIGS. 9C and 9D are cross-sectional views seen from direction B in FIG. 9A. FIGS. 10A to 10D are conceptual diagrams illustrating a magnetic sheet of the non-contact charging module in which the coil has the single layer structure according to the present embodiment, in which FIG. 10A is a top view, FIG. 10B is a cross-sectional view seen from direction A in FIG. 10A, and FIGS. 10C and 10D are cross-sectional views seen from direction Bin FIG. 10A. FIGS. 11A and 11B are conceptual diagrams illustrating a magnetic sheet of the non-contact charging module in which the coil has the single layer structure according to the present embodiment, in which FIG. 11A is a top view and FIG. 11B is a cross-sectional view seen from direction A in FIG. 11A. Circular portion 33a is not provided in FIGS. 9A to 9D to FIGS. 11A and 11B, and coil 21 is also formed by a single copper wire.

As described above, it is preferable that coil 21 have a single layer structure if possible. In this case, it may be considered that all turns of coil 21 in the radial direction are formed in a single layer structure, or that a part thereof is formed in a single layer structure while the remaining part thereof is formed in a double layer structure. Accordingly, it is possible to draw one of terminals 22 and 23 from the outer winding of coil 21, but the other one thereof should be drawn from the inside. Accordingly, a portion where coil 21 is wound and a portion from a winding end point of coil 21 to terminal 22 or 23 are necessarily overlapped with each other in the thickness direction.

Accordingly, in the present invention, linear recess portion 33 or slit 34 is provided in the overlapped portion. Particularly, in FIGS. 10A to 10D, linear recess portion 33 or slit 34 that is parallel to a tangent line of the circumference of an inner circle of the surface of coil 21 and that extends at the shortest distance from a winding start point or a winding end point of the surface of the coil to an edge of magnetic sheet 3, is provided.

In this way, by forming linear portion 33b as shown in FIGS. 10A to 10D, it is possible to form terminal 23 without bending the conducting wire on magnetic sheet 3.

Further, as shown in FIG. 11A, linear portion 33b may be formed on magnetic sheet 3 like recess portion 33 that is perpendicular to the tangent line of the circumference of the inner circle of the surface of coil 21 and that extends at the shortest distance from the winding start point or the winding end point of the surface of the coil to the edge of magnetic sheet 3. Further, FIG. 11A shows only recess portion 33, but slit 34 may be formed as shown in FIG. 10D. Thus, it is possible to suppress an area where recess portion 33 or slit 34 is formed to the minimum, and to enhance transmission efficiency of non-contact charging module 1. That is, by providing recess portion 33 or slit 34, a part of magnetic sheet 3 is removed or becomes thin. Accordingly, there is a possibility that magnetic flux is leaked from recess portion 33 or slit 34 and power transmission efficiency of the non-contact charging module is slightly reduced. Accordingly, by suppressing the area where recess portion 33 or slit 34 is formed to the minimum, in a state where leakage of magnetic flux is suppressed to the minimum and power transmission efficiency of non-contact charging module is maintained, it is possible to achieve reduction in the thickness. In this case, the length of linear portion 33b is about 5 mm to about 10 mm. In FIGS. 11A and 11B, since recess portion 33 is provided to extend from the tangent line of the outer circumference of convex portion 32 to have the shortest distance to the edge of magnetic sheet 3, recess portion 33 has a shape parallel to the edge of magnetic sheet 3, which is because magnetic sheet 3 is a square or rectangular.

As described above, linear portion 33b is similarly formed in a case where circular portion 33a is not present, but recess portion 33 may be extended as much as circular portion 33a is not present. In FIG. 11A recess portion 33 is rectangular when seen from the top, but is not limited thereto. That is, recess portion 33 may be rounded in inner edges so that conducting wire is easily inserted therein, or may be preferably formed in a polygonal shape.

Further, in any case of FIGS. 10A to 10D and FIGS. 11A and 11B, recess portion 33 is parallel to one pair of opposite sides at edges of quadrate magnetic sheet 3 and is perpendicular to the other pair of opposite sides at edges thereof. This is because magnetic sheet 3 of the present embodiment is quadrate. However, the shape of magnetic sheet 3 is not limited to the quadrate shape, and various shapes such as a circle or polygon may be used. Thus, for example, the shape of magnetic sheet 3 may be polygonal, and recess portion 33 or slit 34 may be perpendicular to a side which one end of recess portion 33 or slit 34 meets, thereby making it possible to suppress the area of recess portion 33 or slit 34 to the minimum on a polygonal magnetic sheet to be easily used. Particularly, the shape of magnetic sheet 3 may be quadrate, and recess portion 33 or slit 34 may be parallel to one pair of opposite sides at edges of quadrate magnetic sheet 3 and may be perpendicular to the other pair of opposite sides at edges thereof, thereby making it possible to suppress the area of recess portion 33 or slit 34 to the minimum on a quadrate magnetic sheet to be most easily used.

Next, a non-contact charging instrument that is provided with non-contact charging module 1 of the present invention will be described. A non-contact power transmission instrument includes a charger that includes a power transmission coil and a magnetic sheet, and a main instrument that includes a power reception coil and a magnetic sheet, and the main instrument is an electronic instrument such as a mobile phone. A circuit of the charger side includes a rectifying and smoothing circuit section, a voltage converting circuit section, an oscillating circuit section, a display circuit section, a control circuit section, and the power transmission coil. Further, a circuit of the main instrument side includes the power reception coil, a rectifying circuit section, a control circuit section, and a load L that is mainly formed by a secondary battery.

Power transmission to the main instrument from the charger is performed using electromagnetic induction between the power transmission coil of the charger that is a primary side and the power reception coil of the main instrument that is a secondary side.

Since the non-contact charging instrument according to the present embodiment includes the above-mentioned non-contact charging module, in a state where a sufficient cross-sectional area of a planar coil section is secured and power transmission efficiency is enhanced, it is possible to reduce the size and thickness of the non-contact charging instrument.

The disclosures of Japanese Patent Application No. 2010-267985 and Japanese Patent Application No. 2010-267986, filed on Dec. 1, 2010, including the specification, drawings and abstract, are incorporated herein by reference in its entirety.

### INDUSTRIAL APPLICABILITY

According to the non-contact charging module of the present invention, in a state where a sufficient cross-sectional area of a planar coil section is secured and power transmission efficiency is enhanced, it is possible to reduce the size and thickness of the non-contact charging module, and thus, the present invention is useful for a portable electronic instrument in particular, and is useful as a non-contact charging module of various electronic instruments such as a mobile terminal such as a mobile phone, a portable audio, a portable computer, or a mobile instrument such as a digital camera or a video camera.

### REFERENCE SIGNS LIST

1 Non-contact charging module
2 Planar coil section
21 Coil
22, 23 Terminal
3 Magnetic sheet
31 Flat portion
32 Convex portion
33 Recess portion
34 Slit

1-9. (canceled)

10. A non-contact charging module comprising:
a planar coil in which a conducting wire is wound;
a magnetic sheet including a flat portion on which a surface of the planar coil is mounted; and
a convex portion that is provided in the magnetic sheet and protrudes from the flat portion,
wherein an inner winding of the planar coil surrounds the convex portion.

11. The non-contact charging module according to claim 10, wherein:
the conducting wire is wound around the convex portion.

12. The non-contact charging module according to claim 10, wherein:
the height of the convex portion from the flat portion is the same as the wire diameter of the conducting wire.

13. The non-contact charging module according to claim 10, wherein:
the magnetic sheet includes a different convex portion that protrudes from the flat portion, and
the different convex portion surrounds an outer winding of the planar coil.

14. The non-contact charging module according to claim 10, wherein:
the convex portion provided in the magnetic sheet has the same size as the inner winding of the planar coil.

15. The non-contact charging module according to claim 10, wherein:
the center of the convex portion provided in the magnetic sheet coincides with a central axis of the planar coil.

16. The non-contact charging module according to claim 10, wherein:
the magnetic sheet includes a recess portion or a slit in the flat portion, and
the conducting wire that is overlapped with a wound portion of the planar coil and extends from the inner winding of the planar coil is accommodated in the recess portion or the slit

17. The non-contact charging module according to claim 16, wherein:
an outer appearance of the magnetic sheet is rectangular, and
the recess portion or the slit passes through the center of an arbitrary one side among sides of outer edges of the rectangular magnetic sheet from the inside of the flat portion of the magnetic sheet.

18. The non-contact charging module according to claim 17, wherein:
the recess portion or the slit is perpendicular to the arbitrary one side.

19. The non-contact charging module according to claim 10, wherein:
the planar coil is formed by winding a plurality of the conducting wires.

20. The non-contact charging module according to claim 19, wherein:
the planar coil is formed by winding the plurality of conducting wires in a state where the conducting wires are arranged in parallel on a surface of the magnetic sheet.

21. The non-contact charging module according to claim 10, wherein:
a first wound portion that is a portion of the planar coil is formed by winding the conducting wire in multiple layers; and
a second wound portion that is another portion of the planar coil is formed by winding the conducting wire in the number of layers smaller than that of the first wound portion.

22. The non-contact charging module according to claim 21, wherein:
an annular recess portion or slit formed so as to reduce thickness of the magnetic sheet is provided in a region of the magnetic sheet on which the first wound portion of the planar coil is mounted, and at least a portion of the first wound portion is accommodated in the annular recess portion or slit.

23. The non-contact charging module according to claim 21, wherein:
the planar coil is wound so that the first wound portion is disposed inside the second wound portion.

24. The non-contact charging module according to claim 21, wherein:
the magnetic sheet is provided with a circular recess portion in a portion thereof that is overlapped with the first wound portion, and a portion of the first wound portion that is wound to protrude more than the second wound portion is accommodated in the circular recess portion.
